(19) United States
(12) Patent Application Publication
(10) Pub. No.: US 2025/0348083 A1
(43) Pub. Date: Nov. 13, 2025

(54) COVERAGE PATH PLANNING METHOD FOR MULTIPLE UNMANNED AERIAL VEHICLES IN COMPLEX IRREGULAR AREAS

(71) Applicant: BEIJING INSTITUTE OF TECHNOLOGY, Beijing (CN)

(72) Inventors: Chen CHEN, Beijing (CN); Kai MENG, Beijing (CN); Fang DENG, Beijing (CN); Zonghong JIANG, Beijing (CN); Zhao ZHANG, Beijing (CN); Maobin LV, Beijing (CN)

(73) Assignee: BEIJING INSTITUTE OF TECHNOLOGY, Beijing (CN)

(21) Appl. No.: 18/932,653

(22) Filed: Oct. 31, 2024

(30) Foreign Application Priority Data
May 13, 2024 (CN) 202410590631.7

(51) Int. Cl. G05D 1/644; G05D 1/69; G05D 101/10; G05D 109/20

(52) U.S. Cl. CPC G05D 1/644; G05D 1/69; G05D 2101/10; G05D 2109/20

(57) ABSTRACT

A coverage path planning (CPP) method for multiple unmanned aerial vehicles (UAVs) in complex irregular areas includes: acquiring a plurality of regular sub-areas through a multi-strategy recursive optimal decomposition approach to address the problem of excessive decomposition of a concave vertex; and proposing, by considering the efficiency of solving for an access order among different areas, an adaptive large neighborhood search method to quickly acquire the access order among the areas, thereby acquiring a complete coverage planning path. Compared with existing methods, the CPP method can quickly and efficiently achieve coverage of complex irregular areas, improving the efficiency of UAV path planning. In addition, the CPP method has universality and is applicable to any unmanned system operating on a plane, with high practical value.

### CROSS REFERENCE TO THE RELATED APPLICATIONS

This application is based upon and claims priority to Chinese Patent Application No. 202410590631.7, filed on May 13, 2024, the entire contents of which are incorporated herein by reference.

### TECHNICAL FIELD

The present disclosure belongs to the technical field of unmanned aerial vehicle (UAV) path planning, and in particular to a coverage path planning (CPP) method for multiple UAVs in complex irregular areas.

### BACKGROUND

In recent years, UAVs have been widely used in civilian and military fields such as search and rescue, environmental monitoring, precision agriculture, and battlefield intelligence gathering due to their high flexibility. In these applications, planning a path that covers an area with minimal cost is a key issue, which can be attributed to the CPP problem.

In existing research, most CPP tasks mainly focus on a single simple polygon area, with the aim of finding the optimal path that can cover the target area. There has not been much research on planning paths for a plurality of non-intersecting complex areas. The problem of multi-area CPP requires simultaneous consideration of the access order between areas, the intra-area coverage paths, and entrance and exit locations of each area.

Regarding the multi-area CPP problem, the prior art has the following limitations. Firstly, for irregular polygon areas, the prior art is unable to avoid or reduce the direct impact of concave polygons on the coverage path, and eliminating key concave vertexes will affect the effectiveness of path optimization. Secondly, the prior art overlooks the connection between the access order and intra-area paths, leading to inefficiencies in planning and increased computational load in existing algorithms.

### SUMMARY

To solve the above problems, the present disclosure provides a coverage path planning (CPP) method for multiple unmanned aerial vehicles (UAVs) in complex irregular areas. The present disclosure decomposes an irregular concave area into regular convex sub-areas, improving intra-area coverage efficiency and avoiding redundant or invalid paths.

A CPP method for multiple UAVs in complex irregular areas is provided, including the following steps:
S1: acquiring, through a random generation method, various task areas that the UAVs require to cover when executing a given task;
S2: decomposing an irregular concave polygon task area into a plurality of regular convex polygon task sub-areas through a multi-strategy recursive polygon decomposition method;
S3: acquiring an optimal coverage path in each of regular convex polygon task areas and task sub-areas through a boustrophedon coverage method; and
S4: acquiring an optimal access order among the regular convex polygon task areas and task sub-areas through an adaptive large neighborhood search (ALNS) algorithm, thereby completing multi-area CPP.

Further, the irregular concave polygon task area is decomposed into the plurality of regular convex polygon task sub-areas by the following steps:
S21: generating edge vectors corresponding to edges of a current irregular concave polygon task area in a counterclockwise direction; calculating a cross product of each two of the edge vectors connected to a same vertex sequentially; and determining whether the vertex corresponding to each cross product is a concave vertex based on a magnitude of a modulus of each cross product as follows: determining that, if the modulus of the cross product is greater than 0, the vertex corresponding to the cross product is a convex vertex; determining that, if the modulus of the cross product is less than 0, the vertex corresponding to the cross product is the concave vertex; and determining that, if the modulus of the cross product is equal to 0, the two of the edge vectors corresponding to the cross product are collinear;
S22: taking each concave vertex as a decomposed concave vertex; extending the two of the edge vectors at the decomposed concave vertex to intersect the edges of the current irregular concave polygon task area; and taking an area enclosed by intersecting parts as a visible area of the decomposed concave vertex; and
S23: decomposing the current irregular concave polygon task area based on whether there is a vertex within the visible area of the decomposed concave vertex as follows: if there are a plurality of concave vertexes in the visible area, selecting one of the plurality of concave vertexes closest to the decomposed concave vertex as a closest concave vertex, and connecting the decomposed concave vertex and the closest concave vertex to achieve decomposition of the current irregular concave polygon task area; if there is no concave vertex in the visible area, selecting a vertex closest to the decomposed concave vertex as a closest vertex, and connecting the decomposed concave vertex and the closest vertex to achieve the decomposition of the current irregular concave polygon task area; and if there is no vertex in the visible area, achieving the decomposition of the current irregular concave polygon task area by an angular bisector of the decomposed concave vertex.

Further, each of the regular convex polygon task areas and task sub-areas is taken as a path planning area, and the optimal coverage path in the path planning area is acquired through the boustrophedon coverage method as follows:
acquiring an edge span corresponding to each edge in a current path planning area, and taking a minimum edge span as a minimum width of the current path planning area; and
sweeping the current path planning area sequentially in a direction perpendicular to the minimum width to acquire the optimal coverage path corresponding to the current path planning area.

Further, the step of acquiring the optimal access order among the regular convex polygon task areas and task sub-areas through the ALNS algorithm includes:
S41: taking the regular convex polygon task areas and task sub-areas as areas to be sorted;
S42: generating, in a random manner, different initial feasible solutions from access orders of the areas to be sorted, and selecting a feasible solution with a smallest fitness value from a solution set X_{old} of current initial feasible solutions as a global optimal solution

$${X}_{old}^{*} ;$$

S43: selecting, through a roulette method, a relevant operator from an operator pool to update the solution set X_{old} of the current initial feasible solutions, thereby acquiring an updated solution set X_{new};
S44: selecting a feasible solution with a smallest fitness value from the updated solution set X_{new} as a global optimal solution

$${X}_{new}^{*} ;$$

S45: determining whether two conditions as follows are met: a current iteration count reaches a set upper limit, and a current annealing temperature reaches a termination temperature; taking the global optimal solution

$${X}_{new}^{*}$$

as a final optimal access order if one of the two conditions is met; and proceeding to the step S46 if neither of the two conditions is met; and
S46: determining whether a fitness value

$$F ( {X}_{new}^{*} )$$

corresponding to me global optimal solution

$${X}_{new}^{*}$$

is less than a fitness value

$$F ( {X}_{old}^{*} )$$

corresponding to the global optimal solution

$${X}_{old}^{*} ;$$

taking, if yes, the solution set X_{new} as a new solution set X_{old}, adjusting a value of the current annealing temperature T_{c} according to a set rule, and repeating the steps S43 to S45; and extracting, if not, a part of the solution set X_{new} and a part of the solution set X_{old} according to a set probability

$${e}^{- \frac{F ( {X}_{new}^{*} ) - F ( {X}_{old}^{*} )}{{T}_{c}}}$$

to form the new solution set X_{old}, adjusting the value of the current annealing temperature T_{c} according to the set rule, and repeating the steps S43 to S45.

Further, each vertex of the areas to be sorted serves as an access exit or access entrance, so the optimal access order for the areas to be sorted is an access order of the access exit or access entrance;
operators in the operator pool include a 2-opt operator, a 3-opt operator, a destruction-repair operator 1, and a destruction-repair operator 2;
where, the 2-opt operator is configured to randomly select two areas to be sorted from the access order of the areas to be sorted corresponding to the current feasible solution and arrange an area to be sorted between the two areas to be sorted in reverse order;
the 3-opt operator is configured to randomly delete a connection among three non-adjacent access exits and access entrances from the access order of the areas to be sorted corresponding to the current feasible solution to acquire an idle access entrance and an idle access exit of the areas to be sorted, and randomly connect an occupied access entrance and an occupied access exit to the idle access entrance and the idle access exit;
the destruction-repair operator 1 is configured to randomly select an area to be sorted from the areas to be sorted corresponding to the current feasible solution, delete a connection between the access exit and the access entrance of the area to be sorted and the access exit and the access entrance of another area to be sorted to acquire an idle access entrance and an idle access exit of the area to be sorted, and randomly connect an occupied access entrance and an occupied access exit to the idle access entrance and the idle access exit; and
the destruction-repair operator 2 is configured to randomly select two areas to be sorted from the areas to be sorted corresponding to the current feasible solution, delete a connection among the access exits and access entrances of the two areas to be sorted and the access exit and the access entrance of another area to be sorted to acquire idle access entrances and idle access exits of the two areas to be sorted, and randomly connect an occupied access entrance and an occupied access exit to the idle access entrances and the idle access exits.

Further, the value of the current annealing temperature T_{c} is specifically adjusted according to the set rule as follows:

$${T}_{c}^{*} = α {T}_{c}$$

where,

$${T}_{c}^{*}$$

denotes an adjusted annealing temperature, and α denotes a cooling rate.

Further, the fitness value is calculated based on a length of an access path formed by the access order corresponding to a feasible solution and energy consumption required by the UAVs in a current access order; and a shorter length of the access path and lower energy consumption indicate a smaller fitness value.

### Advantages

1. The present disclosure provides a CPP method for multiple UAVs in complex irregular areas. Firstly, the method acquires a plurality of regular sub-areas through a multi-strategy recursive optimal decomposition approach, addressing the problem of excessive decomposition of a concave vertex. Then, considering the efficiency of solving for the access order among different areas, the method proposes an ALNS algorithm to quickly acquire the access order among the areas, and thus acquire a complete coverage planning path. Compared with existing methods, the present disclosure can quickly and efficiently achieve coverage of complex irregular areas, improving the efficiency of UAV path planning. In addition, the planning method proposed by the present disclosure has universality and is applicable to any unmanned system operating on a plane, with high practical value.
2. The present disclosure provides a CPP method for multiple UAVs in complex irregular areas. Based on the characteristics of the coverage issue, the present disclosure considers the distribution of the access entrance and the exit of each regular area when acquiring access paths among regular areas through the ALNS algorithm, and updates the access order through different operators, improving the efficiency of UAV path planning.

### BRIEF DESCRIPTION OF THE DRAWINGS

FIG. 1 is a flow block diagram of a coverage path planning (CPP) method for multiple unmanned aerial vehicles (UAVs) in complex irregular areas according to the present disclosure.

FIG. 2 is a schematic diagram of a scenario for a UAV coverage task area according to the present disclosure.

FIG. 3A shows a solution of concave vertex decomposition by connecting two concave vertexes according to the present disclosure.

FIG. 3B shows a solution of concave vertex decomposition by connecting a concave vertex and a convex vertex according to the present disclosure.

FIG. 3C shows a solution of concave vertex decomposition by an angular bisector according to the present disclosure.

FIG. 4 is a schematic diagram of a span of a task area according to the present disclosure.

FIG. 5A is a schematic diagram of a coverage path along a minimum span according to the present disclosure.

FIG. 5B is a schematic diagram of an optimal coverage path according to the present disclosure.

FIG. 6 is a diagram of CPP for multiple UAVs according to the present disclosure.

FIG. 7 is a diagram of a convergence curve for solving CPP by the method according to the present disclosure.

FIG. 8 is a schematic diagram of a 2-opt operator according to the present disclosure.

FIG. 9 is a schematic diagram of a 3-opt operator according to the present disclosure.

FIG. 10 is a schematic diagram of a destruction-repair operator 1 according to the present disclosure.

FIG. 11 is a schematic diagram of a destruction-repair operator 2 according to the present disclosure.

### DETAILED DESCRIPTION OF THE EMBODIMENTS

To help persons skilled in the art better understand the solutions of the present disclosure, the technical solutions in the embodiments of the present disclosure are clearly and completely described below with reference to the drawings in the embodiments of the present disclosure.

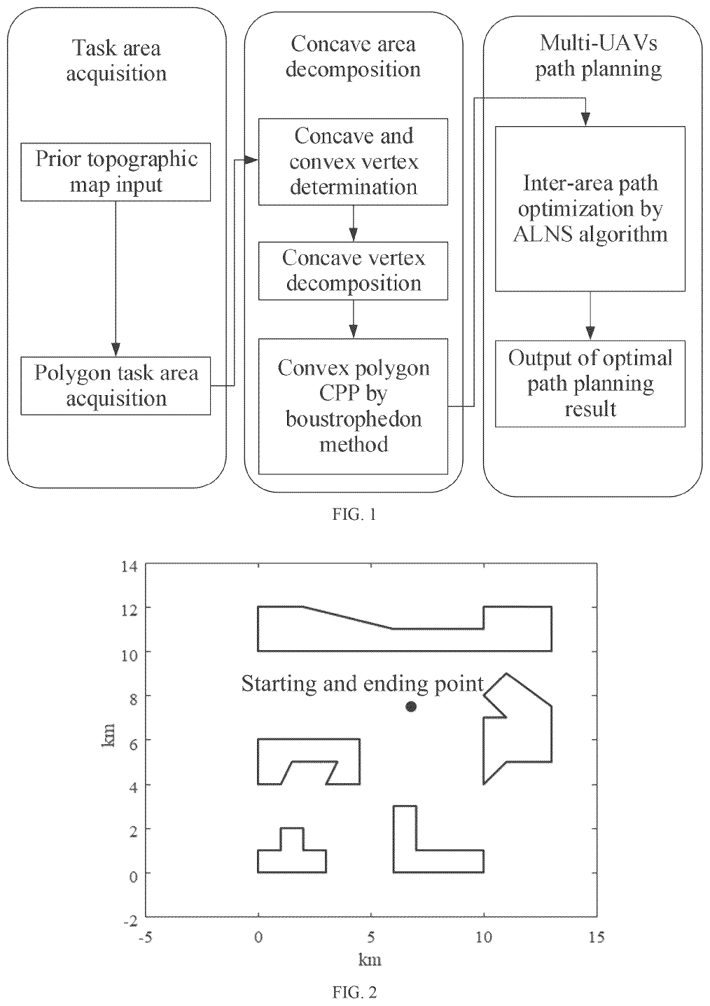

As shown in FIG. 1, a coverage path planning (CPP) method for multiple unmanned aerial vehicles (UAVs) in complex irregular areas includes the following steps.
S1. Various task areas that UAVs require to cover when executing a given task are acquired through a random generation method. As shown in FIG. 2, there are five connected irregular areas in the task scenario, namely area 1, area 2, area 3, area 4, and area 5. Among them, the area 1 includes vertexes (0,0), (0,3), (3,1), (2,1), (2,2), (1,2), (1,1), and (0,1). The area 2 includes vertexes (6,0), (10,0), (10,1), (7,1), (7,3), and (6,3). The area 3 includes vertexes (0,4), (1,4), (1.5,5), (3.5,5), (3,4), (4.5,4), (4.5,6), and (0,6). The area 4 includes vertexes (10,4), (11,5), (13,7.5), (11,9), (10,8), (11,7), and (10,7). The area 5 includes vertexes (0,10), (13,10), (13,12), (10,12), (10,11), (6,11), (2,12), and (0,12). The starting and ending coordinates are (7,7.5).
S2. An irregular concave polygon task area is decomposed into a plurality of regular convex polygon task sub-areas through a multi-strategy recursive polygon decomposition method.

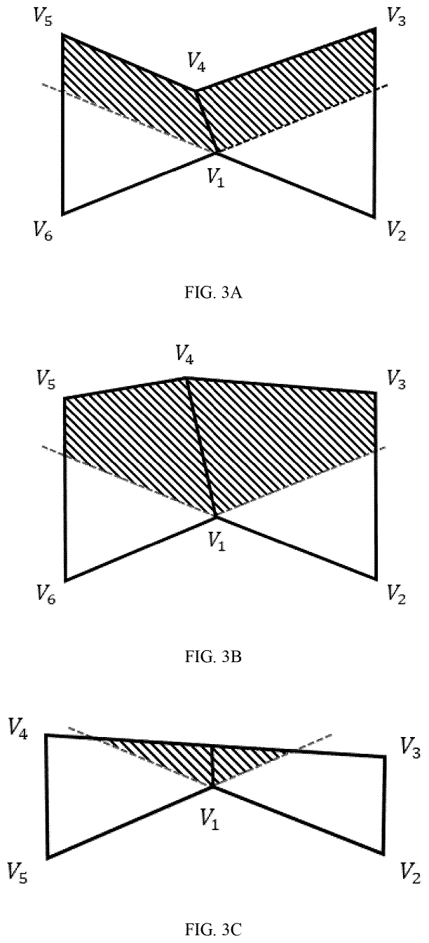

Any irregular concave polygon task area is decomposed into a plurality of regular convex polygon task sub-areas by the following steps.
S21. Edge vectors corresponding to edges of a current irregular concave polygon task area are generated in a counterclockwise direction. A cross product of each two edge vectors connected to a same vertex is calculated sequentially. It is determined whether the vertex corresponding to each cross product is a concave vertex based on a magnitude of a modulus of each cross product. If the modulus of the cross product is greater than 0, it is determined that the vertex corresponding to the cross product is a convex vertex. If the modulus of the cross product is less than 0, it is determined that the vertex corresponding to the cross product is a concave vertex. If the modulus of the cross product is equal to 0, it is determined that the two edge vectors corresponding to the cross product are collinear.
S22. Each concave vertex is taken as a decomposed concave vertex. The two vectors at the decomposed concave vertex extend to intersect the edges of the current task area. An area enclosed by intersecting parts is taken as a visible area of the decomposed concave vertex, indicated by the shaded part in FIG. 3A to FIG. 3B.
S23. The current task area is decomposed based on whether there is a vertex (concave or convex) within the visible area of the decomposed concave vertex. If there are a plurality of concave vertexes in the visible area, a concave vertex closest to the decomposed concave vertex is selected, and the decomposed concave vertex and the closest concave vertex are connected to achieve the decomposition of the current task area, as shown in FIG. 3A. If there is no concave vertex in the visible area, a vertex closest to the decomposed concave vertex is selected, and the decomposed concave vertex and the closest vertex are connected to achieve the decomposition of the current task area, as shown in FIG. 3B. If there is no vertex in the visible area, the decomposition of the current task area is achieved by an angular bisector of the decomposed concave vertex, as shown in FIG. 3C.
S3. An optimal coverage path in each of the regular convex polygon task areas and task sub-areas is acquired through a boustrophedon coverage method.

Each of the regular convex polygon task areas and task sub-areas is taken as a path planning area, and the optimal coverage path in the path planning area is acquired through the boustrophedon coverage method as follows.
S31. An edge span corresponding to each edge in a current path planning area is acquired, and a minimum edge span is taken as a minimum width of the current path planning area. The edge span is calculated by calculating distances between a certain edge of the sub-area and vertexes outside the edge and finding a maximum value of these distances as the span of the corresponding edge.

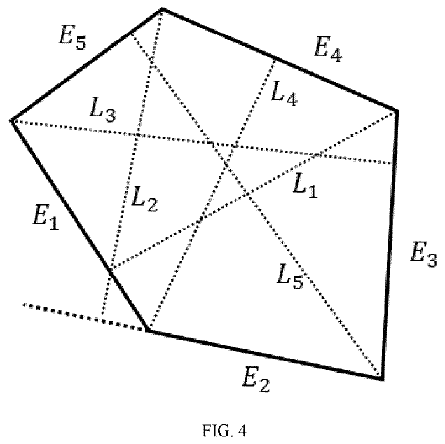

As shown in FIG. 4, the span corresponding to the edge E1 is L1, and the span corresponding to the edge E2 is L2. Similarly, the span corresponding to the edge E5 is L5. Finally, the minimum span corresponding to all edges is found as the minimum width of the sub-area.
S32. The current path planning area is swept sequentially in a direction perpendicular to the minimum width to acquire the optimal coverage path corresponding to the current path planning area.

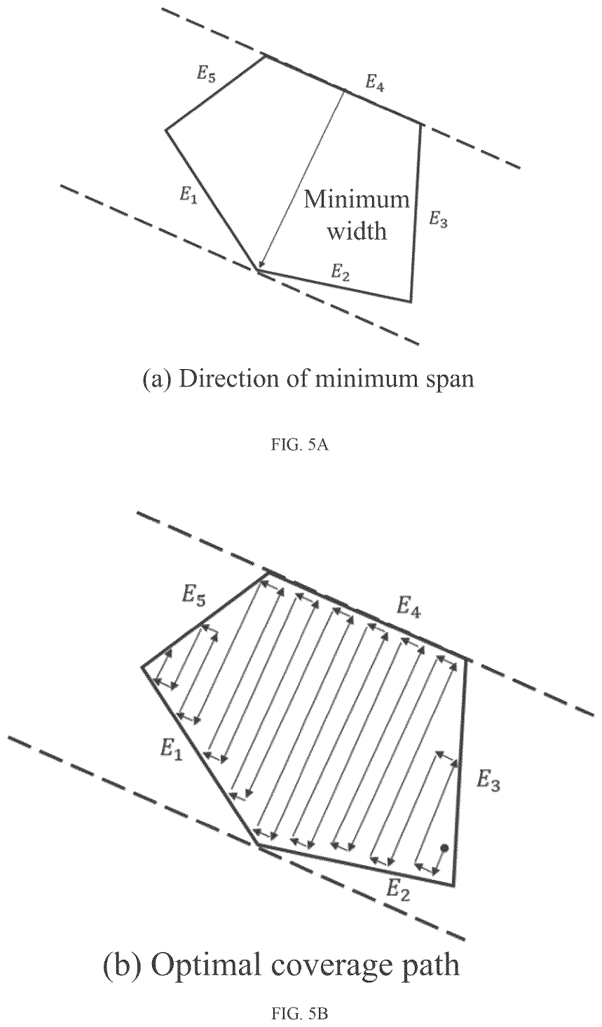

As shown in FIG. 5A, the two dashed lines are the supporting parallel lines corresponding to the minimum width, and they are perpendicular to the direction of the minimum width. Thus, the optimal coverage path of the area is generated, as shown in FIG. 5B.
S4. An optimal access order among the regular convex polygon task areas and task sub-areas is acquired through an ALNS algorithm, thereby completing multi-area CPP.

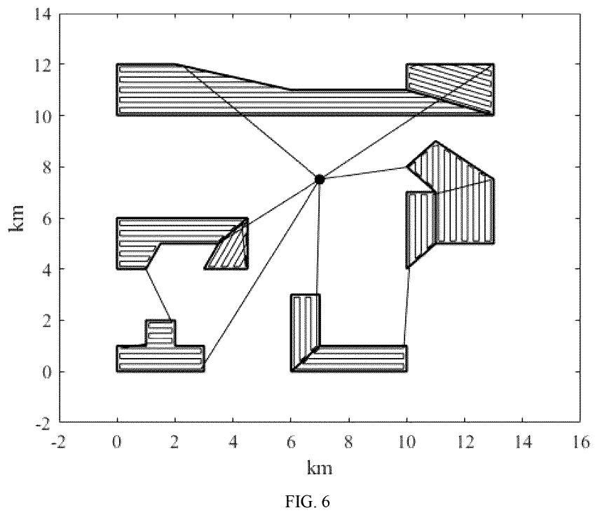

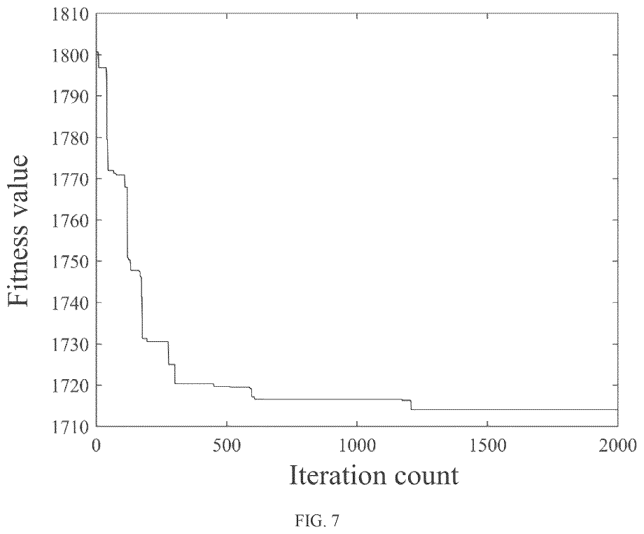

The finally planned path result is shown in FIG. 6, and its algorithm convergence curve is shown in FIG. 7. Meanwhile, the method for acquiring the optimal access order specifically includes the following steps.
S41. The regular convex polygon task areas and task sub-areas are taken as areas to be sorted.
S42. Different initial feasible solutions are generated from access orders of the areas to be sorted in a random manner, and a feasible solution with a smallest fitness value is selected from a solution set X_{old} of current initial feasible solutions as a global optimal solution

$${X}_{old}^{*} .$$

The fitness value is calculated based on a length of an access path formed by the access order corresponding to a feasible solution and energy consumption required by the UAV in a current access order. A shorter length of the access path and lower energy consumption indicate a smaller fitness value.
S43. A relevant operator is selected from an operator pool through a roulette method to update the solution set X_{old} of the current initial feasible solutions, thereby acquiring an updated solution set X_{new}.

It should be noted that, each vertex of the areas to be sorted serves as an access exit or access entrance, so the optimal access order for the areas to be sorted is an access order of the access exit or access entrance.

Operators in the operator pool include a 2-opt operator, a 3-opt operator, a destruction-repair operator 1, and a destruction-repair operator 2.

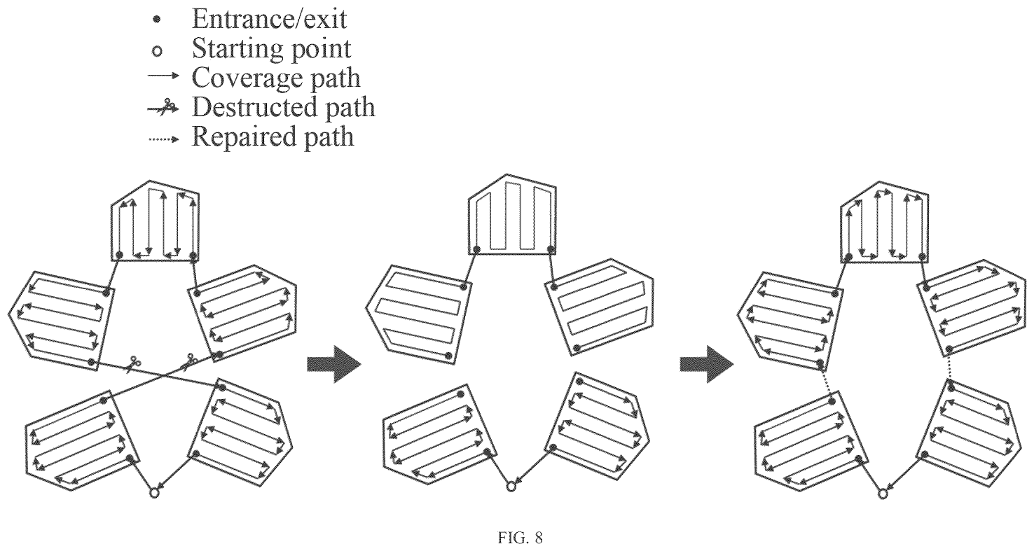

As shown in FIG. 8, the 2-opt operator is configured to randomly select two areas to be sorted from the access order of the areas to be sorted corresponding to the current feasible solution and arrange an area to be sorted between the two areas to be sorted in reverse order.

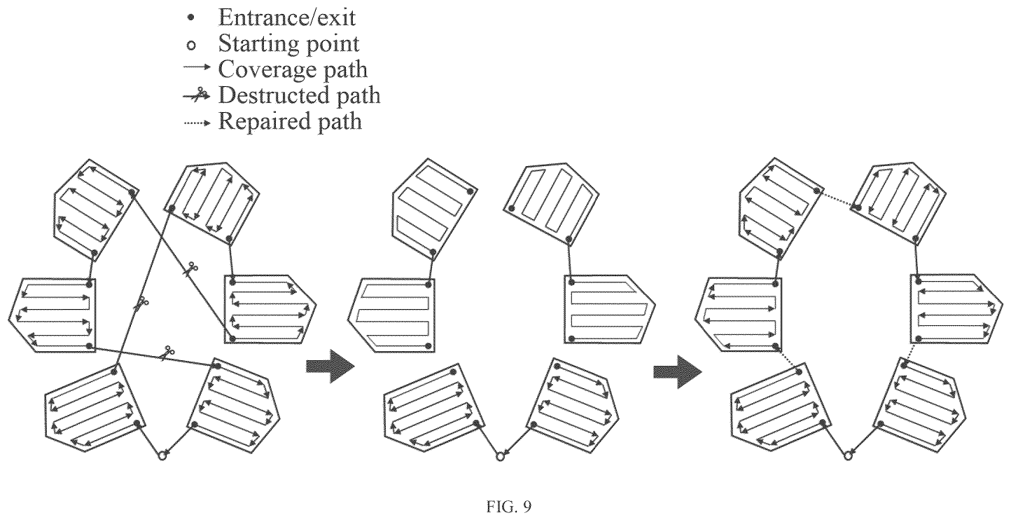

As shown in FIG. 9, the 3-opt operator is configured to randomly delete a connection between three non-adjacent access exits and access entrances from the access order of the areas to be sorted corresponding to the current feasible solution to acquire an idle access entrance and an idle access exit of the areas to be sorted, and randomly connect an occupied access entrance and an occupied access exit to the idle access entrance and the idle access exit.

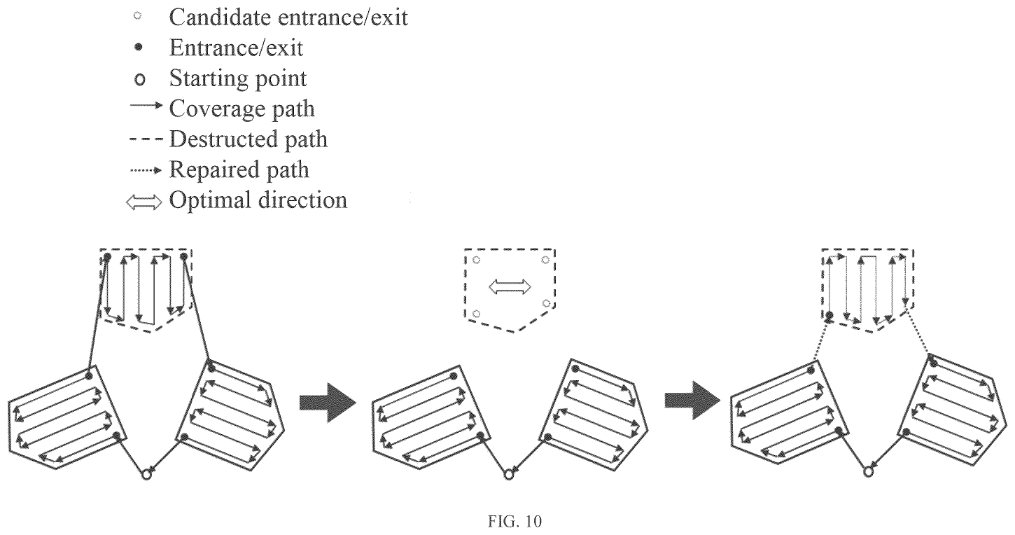

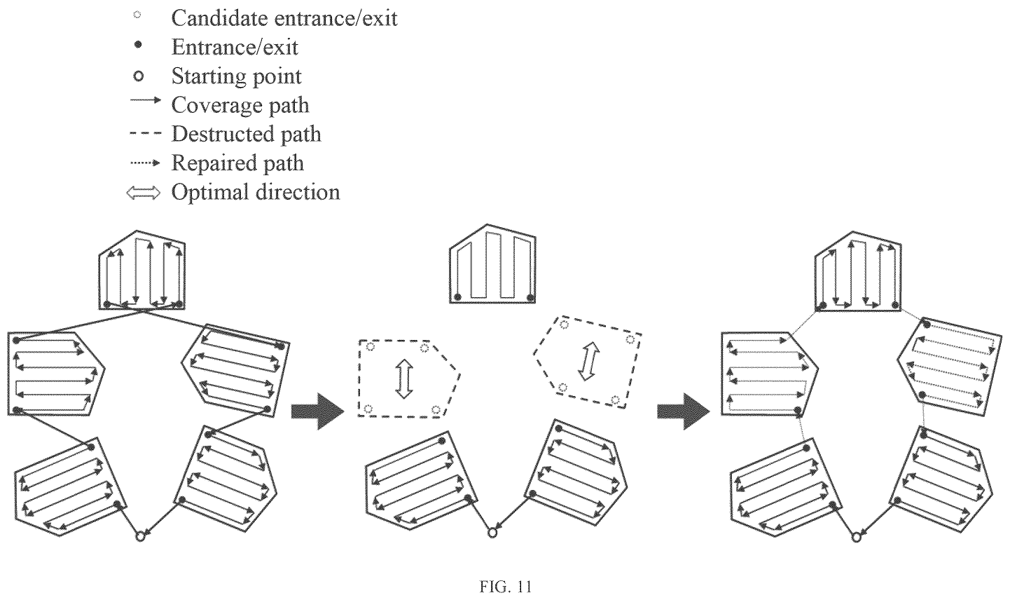

As shown in FIG. 10, the destruction-repair operator 1 is configured to randomly select an area to be sorted from the areas to be sorted corresponding to the current feasible solution, delete a connection between the access exit and the access entrance of the area to be sorted and the access exit and the access entrance of another area to be sorted to acquire an idle access entrance and an idle access exit of the area to be sorted, and randomly connect an occupied access entrance and an occupied access exit to the idle access entrance and the idle access exit.

As shown in FIG. 11, the destruction-repair operator 2 is configured to randomly select two areas to be sorted from the areas to be sorted corresponding to the current feasible solution, delete a connection between the access exits and access entrances of the two areas to be sorted and the access exit and the access entrance of another area to be sorted to acquire idle access entrances and idle access exits of the two areas to be sorted, and randomly connect an occupied access entrance and an occupied access exit to the idle access entrances and the idle access exits.
S44. A feasible solution with a smallest fitness value is selected from the updated solution set X_{new} as a global optimal solution

$${X}_{new}^{*} .$$

S45. It is determined whether two conditions as follows are met: a current iteration count reaches a set upper limit, and a current annealing temperature reaches a termination temperature T₀. If one of the two conditions is met, the global optimal solution

$${X}_{new}^{*}$$

is taken as a final optimal access order. If neither of the two conditions is met, the method proceeds to the step S46.
S46. It is determined whether the fitness value

$$F ( {X}_{new}^{*} )$$

corresponding to the global optimal solution

$${X}_{new}^{*}$$

is less than the fitness value

$$F ( {X}_{old}^{*} )$$

corresponding to the global optimal solution

$${X}_{old}^{*} .$$

If yes, the solution set X_{new} is taken as a new solution set X_{old}, a value of the current annealing temperature T_{c} is adjusted according to a set rule, and the steps S43 to S45 are repeated. If not, a part of the solution set X_{new} and a part of the solution set X_{old} are extracted according to a set probability

$${e}^{- \frac{F ( {X}_{new}^{*} ) - F ( {X}_{old}^{*} )}{{T}_{c}}}$$

to form the new solution set X_{old}, the value of the current annealing temperature T_{c} is adjusted according to the set rule, and the steps S43 to S45 are repeated.

That is to say, according to the Metropolis criterion, the present disclosure calculates the updated solution set X_{new} based on the probability p as follows:

$$p = \{ \begin{matrix}1 , & F ( {X}_{n e w}^{*} ) - F ( {X}_{o l d}^{*} ) < 0 \\ {e}^{- \frac{F ( {X}_{new}^{*} ) - F ( {X}_{old}^{*} )}{{T}_{c}}} , & Others\end{matrix}$$

In other words, if

$$F ( {X}_{new}^{*} ) - F ( {X}_{old}^{*} ) \geq 0 ,$$

the P % of the current solutions of the solution set X_{new} and 1−P % of the current solutions of the solution set X_{old} are randomly extracted and combined into a new set X_{new}.

Further, the value of the current annealing temperature T_{c} is specifically adjusted according to the set rule as follows:

$${T}_{c}^{*} = α {T}_{c}$$

where,

$${T}_{c}^{*}$$

denotes an adjusted annealing temperature, and α denotes a cooling rate.

Overall, the present disclosure provides a CPP method for multiple UAVs in complex irregular areas. Firstly, the present disclosure decomposes an irregular concave area into regular convex sub-areas through a multi-strategy recursive polygon decomposition approach, improving coverage efficiency within the area and avoiding redundant or invalid paths. Then, based on the characteristics of the coverage issue, the present disclosure considers the distribution of access entrances and exits of each area, and proposes an ALNS algorithm to acquire the access path between areas. Compared with existing methods, the present disclosure can quickly and efficiently achieve coverage of complex irregular areas, improving the efficiency of UAV path planning. In addition, the planning method proposed by the present disclosure has universality and is applicable to any unmanned system operating on a plane, with high practical value.

Certainly, the present disclosure may further include other various embodiments. Those skilled in the art can make various corresponding modifications and variations according to the present disclosure without departing from the spirit and essence of the present disclosure, but all these corresponding modifications and variations shall fall within the protection scope defined by the appended claims in the present disclosure.

1. A coverage path planning (CPP) method for multiple unmanned aerial vehicles (UAVs) in complex irregular areas, comprising the following steps:
S1: acquiring, through a random generation method, various task areas, wherein the multiple UAVs require to cover the various task areas when executing a given task;
S2: decomposing an irregular concave polygon task area into a plurality of regular convex polygon task sub-areas through a multi-strategy recursive polygon decomposition method;
S3: acquiring an optimal coverage path in each of regular convex polygon task areas and the plurality of regular convex polygon task sub-areas through a boustrophedon coverage method; and
S4: acquiring an optimal access order among the regular convex polygon task areas and the plurality of regular convex polygon task sub-areas through an adaptive large neighborhood search (ALNS) algorithm, thereby completing a multi-area CPP.

2. The CPP method for the multiple UAVs in the complex irregular areas according to claim 1, wherein the irregular concave polygon task area is decomposed into the plurality of regular convex polygon task sub-areas by the following steps:
S21: generating edge vectors corresponding to edges of a current irregular concave polygon task area in a counterclockwise direction; calculating a cross product of each two of the edge vectors connected to a same vertex sequentially; and determining whether the vertex corresponding to each cross product is a concave vertex based on a magnitude of a modulus of each cross product as follows: determining that, when the modulus of the cross product is greater than 0, the vertex corresponding to the cross product is a convex vertex; determining that, when the modulus of the cross product is less than 0, the vertex corresponding to the cross product is the concave vertex; and determining that, when the modulus of the cross product is equal to 0, two of the edge vectors corresponding to the cross product are collinear;
S22: taking each concave vertex as a decomposed concave vertex; extending two of the edge vectors at the decomposed concave vertex to intersect the edges of the current irregular concave polygon task area; and taking an area enclosed by intersecting parts as a visible area of the decomposed concave vertex; and
S23: decomposing the current irregular concave polygon task area based on whether there is a vertex within the visible area of the decomposed concave vertex as follows: when there are a plurality of concave vertexes in the visible area, selecting one of the plurality of concave vertexes closest to the decomposed concave vertex as a closest concave vertex, and connecting the decomposed concave vertex and the closest concave vertex to achieve a first decomposition of the current irregular concave polygon task area; when there is no concave vertex in the visible area, selecting a vertex closest to the decomposed concave vertex as a closest vertex, and connecting the decomposed concave vertex and the closest vertex to achieve a second decomposition of the current irregular concave polygon task area; and when there is no vertex in the visible area, achieving a third decomposition of the current irregular concave polygon task area by an angular bisector of the decomposed concave vertex.

3. The CPP method for the multiple UAVs in the complex irregular areas according to claim 1, wherein each of the regular convex polygon task areas and the plurality of regular convex polygon task sub-areas is taken as a path planning area, and the optimal coverage path in the path planning area is acquired through the boustrophedon coverage method as follows:
acquiring an edge span corresponding to each edge in a current path planning area, and taking a minimum edge span as a minimum width of the current path planning area; and
sweeping the current path planning area sequentially in a direction perpendicular to the minimum width to acquire the optimal coverage path corresponding to the current path planning area.

4. The CPP method for the multiple UAVs in the complex irregular areas according to claim 1, wherein the step of acquiring the optimal access order among the regular convex polygon task areas and the plurality of regular convex polygon task sub-areas through the ALNS algorithm comprises:
S41: taking the regular convex polygon task areas and the plurality of regular convex polygon task sub-areas as areas to be sorted;
S42: generating, in a random manner, different initial feasible solutions from access orders of the areas to be sorted, and selecting a first feasible solution with a smallest fitness value from a solution set X_{old} of current initial feasible solutions as a global optimal solution
$${X}_{old}^{*} ;$$
S43: selecting, through a roulette method, a relevant operator from an operator pool to update the solution set X_{old} of the current initial feasible solutions, thereby acquiring an updated solution set X_{new};
S44: selecting a second feasible solution with a smallest fitness value from the updated solution set X_{new} as a global optimal solution
$${X}_{new}^{*} ;$$
S45: determining whether two conditions as follows are met: a current iteration count reaches a set upper limit, and a current annealing temperature T_{c} reaches a termination temperature; taking the global optimal solution
$${X}_{new}^{*}$$
as a final optimal access order when one of the two conditions is met; and proceeding to a step S46 when neither of the two conditions is met; and
S46: determining whether a fitness value
$$F ( {X}_{new}^{*} )$$
corresponding to the global optimal solution
$${X}_{new}^{*}$$
is less than a fitness value
$$F ( {X}_{old}^{*} )$$
corresponding to the global optimal solution
$${X}_{old}^{*} ;$$
when the fitness value
$$F ( {X}_{new}^{*} )$$
is less than the fitness value
$$F ( {X}_{old}^{*} ) ,$$
taking the updated solution set X_{new} as a first new solution set X_{old}, adjusting a value of the current annealing temperature T_{c} according to a set rule, and repeating the steps S43 to S45; and when the fitness value
$$F ( {X}_{new}^{*} )$$
is greater than or equal to the fitness value
$$F ( {X}_{old}^{*} ) ,$$
extracting a part of the updated solution set X_{new} and a part of the solution set X_{old} according to a set probability
$${e}^{- \frac{F ( {X}_{new}^{*} ) - F ( {X}_{old}^{*} )}{{T}_{c}}}$$
to form a second new solution set X_{old}, adjusting the value of the current annealing temperature T_{c} according to the set rule, and repeating the steps S43 to S45.

5. The CPP method for the multiple UAVs in the complex irregular areas according to claim 4, wherein each vertex of the areas to be sorted serves as an access exit or access entrance, so the optimal access order for the areas to be sorted is an access order of the access exit or access entrance;
operators in the operator pool comprise a 2-opt operator, a 3-opt operator, a destruction-repair operator 1, and a destruction-repair operator 2;
wherein, the 2-opt operator is configured to randomly select two areas to be sorted from an access order of the areas to be sorted corresponding to a current feasible solution and arrange a first area to be sorted between the two areas to be sorted in reverse order;
the 3-opt operator is configured to randomly delete a connection among three non-adjacent access exits and access entrances from the access order of the areas to be sorted corresponding to the current feasible solution to acquire an idle access entrance and an idle access exit of the areas to be sorted, and randomly connect a first occupied access entrance and a first occupied access exit to the idle access entrance and the idle access exit of the areas to be sorted;
the destruction-repair operator 1 is configured to randomly select a second area to be sorted from the areas to be sorted corresponding to the current feasible solution, delete a connection between an access exit and an access entrance of the second area to be sorted and an access exit and an access entrance of another area to be sorted to acquire an idle access entrance and an idle access exit of the second area to be sorted, and randomly connect a second occupied access entrance and a second occupied access exit to the idle access entrance and the idle access exit of the second area to be sorted; and
the destruction-repair operator 2 is configured to randomly select two areas to be sorted from the areas to be sorted corresponding to the current feasible solution, delete a connection among access exits and access entrances of the two areas to be sorted and the access exit and the access entrance of another area to be sorted to acquire idle access entrances and idle access exits of the two areas to be sorted, and randomly connect a third occupied access entrance and a third occupied access exit to the idle access entrances and the idle access exits of the two areas to be sorted.

6. The CPP method for the multiple UAVs in the complex irregular areas according to claim 4, wherein the value of the current annealing temperature T_{c} is adjusted according to the set rule as follows:
$${T}_{c}^{*} = α {T}_{c}$$
wherein,
$${T}_{c}^{*}$$
denotes an adjusted annealing temperature, and α denotes a cooling rate.

7. The CPP method for the multiple UAVs in the complex irregular areas according to claim 4, wherein a fitness value is calculated based on a length of an access path formed by an access order corresponding to a feasible solution and energy consumption required by the multiple UAVs in a current access order; and as the length of the access path is shortened and the energy consumption is lowered, the fitness value is decreased.
